(19) United States
(12) Patent Application Publication
(10) Pub. No.: US 2025/0165832 A1
(43) Pub. Date: May 22, 2025

(54) METHOD AND SYSTEM FOR QUANTUM MACHINE LEARNING

(71) Applicant: Standard Chartered Bank, London (GB)

(72) Inventors: Daniel O’CONNOR, London (GB); Shaun GEANEY, London (GB); Elena STRBAC, London (GB); Filip WUDARSKI, Columbia, MD (US); Ata Akbari ASANJAN, Columbia, MD (US); Max WILSON, Columbia, MD (US); Paul Aaron LOTT, Columbia, MD (US); Davide VENTURELLI, Columbia, MD (US)

(21) Appl. No.: 18/511,994

(22) Filed: Nov. 16, 2023

(51) Int. Cl. G06N 10/60; G06F 17/16; G06N 10/20

(52) U.S. Cl. CPC G06N 10/60; G06F 17/16; G06N 10/20

(57) ABSTRACT

In a described embodiment, a hybrid quantum-classical computing method including receiving time dependent input data of a dynamical system, transforming a first element of the input data using a plurality of transformation matrices to obtain a set of transformed data, and encoding the transformed data into a quantum circuit by performing a first set of quantum operations is implemented. The quantum circuit includes a plurality of layers, wherein the layers include data encoding layers, feedback layers, and a random transformation layer is implemented. Encoding a measurement feedback from a previous measurement vector into the quantum circuit is implemented by performing a second set of quantum operations. The quantum circuit operates to generate an updated measurement vector and a reservoir state is generated based on the updated measurement vector, a previous reservoir state vector and the input data.

### TECHNICAL FIELD

The present application pertains generally to methods and systems for quantum computing (QC) and machine learning (ML), and in particular integrating quantum computing algorithms with machine learning techniques for forecasting dynamic environments.

### BACKGROUND

Recent advancements in quantum computing (QC) have signalled shifts in scientific and technological applications, introducing the field of quantum machine learning (QML). QML applies quantum algorithms to enhance conventional machine learning tasks. However, the current phase of technological evolution, known as the noise-intermediate-scale quantum (NISQ) era, is marked by quantum computers with a limited number of qubits and vulnerability to noise. This stage necessitates the development of methodologies that maximize the computational effectiveness of quantum resources within these constraints.

To address or circumvent these limitations, hybrid quantum-classical algorithms have been developed to integrate quantum computational subroutines with classical processing capabilities. The goal is to utilize quantum processors for specific tasks where they offer computational advantages, such as the direct estimation of expectation values through wave function sampling, while relying on classical computers to perform tasks that are currently beyond the scope of or unsuitable for quantum devices, like certain optimization procedures.

Variational Quantum Algorithms (VQAs) represent such hybrid methodologies, utilizing parameterized quantum circuits in combination with classical optimization routines. VQAs are applicable to a variety of problems, from optimization tasks to simulations in quantum chemistry. However, the implementation of VQAs faces challenges including but not limited to, quantum error or noise, parameter optimization, and the efficient management of quantum-classical computation interactions.

In classical machine learning, reservoir computing (RC) has been recognized for its efficacy in simulating complex temporal dynamics using networks that maintain a non-varying internal structure during training, thus simplifying the learning process. The process within an RC system involves a reservoir layer that maintains a state reflecting the temporal dynamics of the input data. It uses a leak rate to manage the influx of new information and a non-linear function to update the state based on both the new input and the previous state. The subsequent state of the system is calculated using an auto-regressive mechanism, which then gets mapped to output data through a readout layer. This layer utilizes ridge regression, a method that helps in generalizing the model's performance and preventing overfitting by adding a regularization term. The optimization of the readout parameters is achieved by solving a linear equation that minimizes the difference between predicted and actual outputs, regularized by a penalty on the size of the readout weights. Consequently, it is desirable to provide a method and system that integrates quantum computing with machine learning to address the disadvantages or limitations of the existing art or, at the very least, provide the public with a useful alternative.

### SUMMARY

The present disclosure aims to provide new and useful methods and systems for quantum machine learning, and in particular integrating quantum computing algorithms with machine learning techniques for forecasting of dynamic environments.

In broad terms, the present disclosure proposes a hybrid quantum-classical computing method including receiving time dependent input data of a dynamical system, transforming a first element of the input data using a plurality of transformation matrices to obtain a set of transformed data, and encoding the transformed data into a quantum circuit by performing a first set of quantum operations. The quantum circuit may include a plurality of layers, wherein the layers include data encoding layers, feedback layers, and a random transformation layer. One way of employing this method is encoding a measurement feedback from a previous measurement vector into the quantum circuit by performing a second set of quantum operations. As it can be appreciated from the described embodiment, the method may operate the quantum circuit to generate an updated measurement vector. A reservoir state may be generated based on the updated measurement vector, a previous reservoir state vector and the input data.

In particular embodiments, the method may further comprise determining whether additional input data is to be processed and forming a reservoir state vector based on one or more of the generated reservoir states, input data, and a bias term.

In implementations, the method may apply a ridge regression procedure to a series of the formed reservoir state vectors to determine a plurality of readout parameters.

The method may generate predictions of a future state of the dynamical system based on the readout parameters and the reservoir state vector.

In implementations, the method may use the quantum circuit and a trained classical processing module to generate predictions of a future state of the dynamical system, wherein the classical processing module receives as input non-linear transformations of the reservoir state and non-linear transformations of the time dependent input data.

In some embodiments, the method may include initiating entanglement among a plurality of qubits of the quantum circuit in the data encoding layers.

In implementations, each of the plurality of transformation matrices may include a plurality of fixed transformation matrices, which remain invariant during both training and prediction phases of the computing process.

In particular embodiments, each of the plurality of transformation matrices may include a random weight matrix or a Fourier-like matrix; and the set of transformed data are generated by performing functional transformations over the first element of the input data.

Each of the first and second set of quantum operations may include one or a combination of one or more of: single-qubit rotations around at least one of X, Y and Z-axes; controlled-Phase gate operation; fSim gate operation; or 2-qubit XY rotation.

In implementations, the method may include encoding the transformed data and encoding the measurement feedback may include a use of feature map functions for transforming data encoded parameters corresponding to a first set of parametrized layers and a second set of parameterized layers.

The reservoir circuit layer may include reservoir units corresponding to a set of quantum gates, wherein parameters of the quantum gates are independent of measurement feedback, input data, or reservoir state.

The quantum circuit may be designed to produce stable measurements for integration with a classical reservoir computing model for enhancing the performance of the classical reservoir computing model.

In some embodiments, the generation of the reservoir state may be based on a plurality of activation functions, which introduce non-linearities into the operations performed by the quantum circuit, and a leak rate parameter.

The updated measurement vector may be generated by measuring a plurality of quantum data elements across at least one of X, Y, and Z bases of orientation.

In particular embodiments, the updated measurement vector may further include single-qubit expectation values and multi-qubit correlators, wherein both the single-qubit expectation values and the multi-qubit correlators are defined on a measurement graph.

The method may be employed for predicting behaviors of chaotic systems and facilitates non-linear transformation of the set of input data via data processing by the quantum framework.

In embodiments, the method may use properties of a highly dimensional Hilbert space as a reservoir for encoding chaotic dynamics into the quantum circuit.

In implementations, the method may include shifting between classical and quantum operations, wherein the classical operations pre-process input data for the quantum operations and further post-processes measurement outcomes corresponding to the quantum operations

In particular embodiments, prior measurements corresponding to the measurement feedback may be derived from the quantum circuit parameterized by a preceding iteration of the computing method, wherein the prior measurements parameterize feedback layers.

Each of the transformation matrices may be a fixed transformation matrix associated with a reservoir state, a measured state, and an input state.

In embodiments, the time dependent input data may include multicomponent time series data vectors.

The method may further use a classical co-processor to receive classical output from the quantum circuit and apply post-processing to produce refined data, and repeat operations that produce classical output to gather statistics for post-processing refinement.

The method may further include steps of repeating quantum circuit operations with each repetition compiled differently to enable post-processing suppression techniques and augmenting a quantum output with a classical co-processor for system enhancement based on accumulated statistics;

The implementations may be expressed as a method, or alternatively as a system including one or more computers and one or more storage devices storing instructions that when executed by the one or more computers cause the one or more computers to perform the method. It may also be expressed as a computer program product, such as downloadable program instructions (software) or one or more non-transitory computer storage media storing instructions. When executed by one or more computers, the program instructions cause the one or more computers to perform the method.

Embodiments described herein may thereby provide a method and system for quantum machine learning that accomplishes one or more of the following properties:

Effectively combining quantum and classical computing strategies to address the challenge of limited qubit availability and quality in current quantum computing hardware.

Enhancing the efficiency and accuracy of machine learning models, particularly in processing and predicting complex temporal dynamics within high-dimensional data.

Reducing the computational burden associated with training quantum models by employing a hybrid approach thereby reducing the use of extensive quantum hardware.

Improving predictions of chaotic systems, which is fundamental for complex simulations like weather modelling or financial markets.

Achieving less sensitivity to random initialization and changes in hyperparameters compared to classical counterparts, while still accurately reproducing long-term system behaviors.

The above description is provided as an overview of some implementations of the present disclosure. Further description of those implementations, and other implementations, are described in more detail below.

### BRIEF DESCRIPTION OF THE DRAWINGS

Embodiments of the invention will now be explained for the sake of example only, with reference to the following figures in which: FIG. 1 is a functional block diagram of an example of a hybrid quantum-classical computing system, according to an embodiment herein.

FIG. 2 is a flowchart illustrating an example high-level process of using the system of FIG. 1 for predicting dynamic environments, according to an embodiment herein.

FIG. 3 is a graphical representation of simulated outcomes for a Lorenz63 chaotic system using a Hybrid Quantum-Classical Reservoir Computing (HQRC) system, according to an embodiment herein.

FIG. 4 is a graphical representation of a Lorenz63 attractor's position over time, demonstrating the HQRC system's accuracy in reconstructing long-term qualitative behaviour, according to an embodiment herein.

FIG. 5 is a graphical representation of the Poincare return map for the Lorenz63 chaotic system, illustrating the orderly oscillatory patterns amidst component-wise divergence after around 30-time units, in accordance with an embodiment presented herein.

FIG. 6 is a graphical representation of simulated outcomes for a double-scroll system using the HQRC system with an 8-qubit structure, according to an embodiment herein.

FIG. 7 is a graphical representation of a reconstructed long-term behaviour based on the attractor for a double-scroll system using an 8-qubit HQRC configuration, according to an embodiment herein.

FIGS. 8A and 8B are graphical representations of the performance of the HQRC algorithm implemented on an Aspen M-3 chip during training and after training when making predictions, using Clifford Data Regression (CDR), according to an embodiment herein.

FIGS. 9A and 9B are graphical representations of the performance of the HQRC algorithm implemented on an Aspen M-3 chip during training and after training when making predictions, without using CDR with 1,000 shots, according to an embodiment herein.

FIGS. 10A and 10B are graphical representations of the performance of the HQRC algorithm implemented on an Aspen M-3 chip during training and after training when making predictions, without using CDR with 10,000 shots, according to an embodiment herein.

FIGS. 11A and 11B are graphical representations of the collective performance of the HQRC algorithm implemented on an Aspen M-3 chip during training and after training when making predictions using CDR, as well as without using CDR with 1,000 shots and 10,000 shots, according to an embodiment herein.

FIGS. 12A and 12B are graphical representations of the performance of the HQRC algorithm implemented on an 8-quit chip provided by Oxford Quantum Circuits (OQC) during training and after training when making predictions, according to an embodiment herein.

FIG. 13 is a graphical representation of the main layer types utilized for benchmarking the Lorenz63 system, illustrating quantum circuit designs with varying configurations of Ry and Rz gates and entanglement patterns across multiple qubits, as well as the specific entanglement pairs within two distinct ring groupings, according to an embodiment herein.

FIGS. 14A, 14B, and 14C are graphical representations of a statistical compilation for the Lorenz63 problem demonstrating the performance impact of different quantum circuit layer types across systems, according to an embodiment herein.

FIGS. 15A, 15B, and 15C are graphical representations of the performance of the HQRC algorithm on a Rigetti Aspen M-3 chip using 8, 16, and 23 qubits respectively, according to an embodiment herein.

FIG. 16 is a block diagram illustrating an example computer system which may be configured to implement the systems and methods as disclosed herein.

FIG. 17 is a schematic representation of a hybrid quantum-classical computing model, according to an embodiment herein.

### DETAILED DESCRIPTION

Embodiments will now be discussed with reference to the accompanying FIGs., which depict one or more exemplary embodiments. These embodiments are described in sufficient detail to enable those skilled in the art to practice the embodiments and it is to be understood that mechanical, logical, and other changes may be made without departing from the scope of the embodiments.

Therefore, embodiments may be implemented in many different forms and should not be construed as limited to the embodiments set forth herein, shown in the FIGs., and/or described below.

Unless otherwise defined, all terms (including technical and scientific terms) used herein are to be interpreted as is customary in the art. It will be further understood that terms in common usage should also be interpreted as is customary in the relevant art.

FIG. 1 a block diagram of an example of a hybrid quantum-classical reservoir system (HQRC) 100 for predicting dynamic environments, according to an embodiment of the present disclosure.

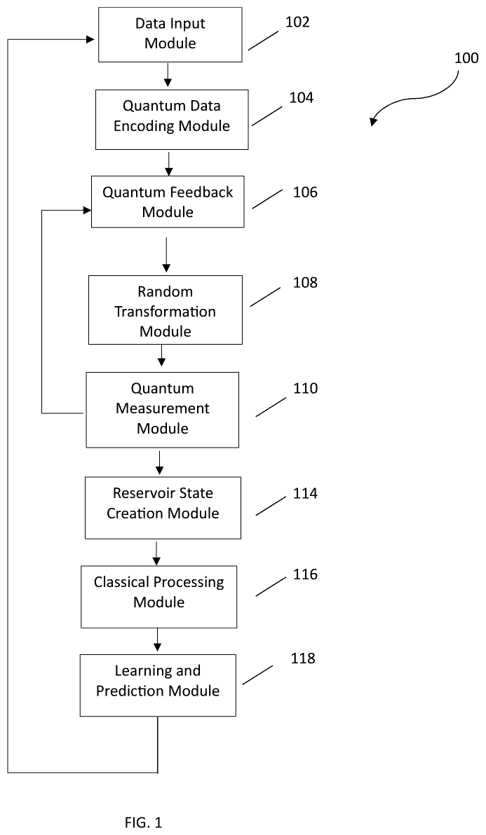

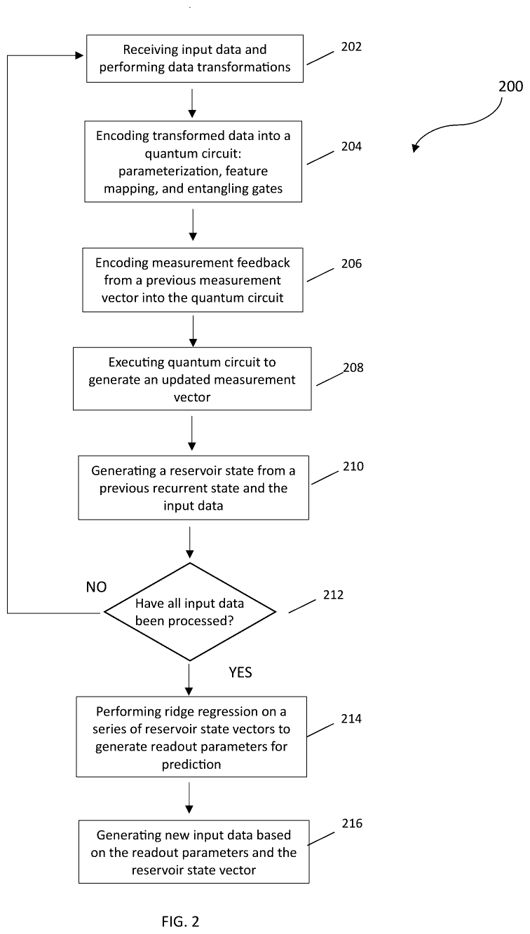

FIG. 2 is a flowchart of an example high-level process 200 of using the system of FIG. 1 for predicting dynamic environments, according to an embodiment of the present disclosure. In the description that follows, components and modules illustrated in FIG. 1 will be referenced in conjunction with the steps outlined in FIG. 2 to explain the functions of the components within the process of predicting dynamic environments.

In example implementations, the HQRC system 100 is a predictive model configured to forecast future states of a time-dependent dynamical system Xₜ. Employing a fixed number n of historical observations at sequential time points t1, t2, . . . , tn, the system 100 learns the inherent patterns of the input data to predict new states at future times, tₙ₊₁, tn+2, . . . , tn+p, which correspond to the dynamical system's Xₜ true trajectory. In embodiments, the system 100 may integrate both classical and quantum computational modules for predicting the future states.

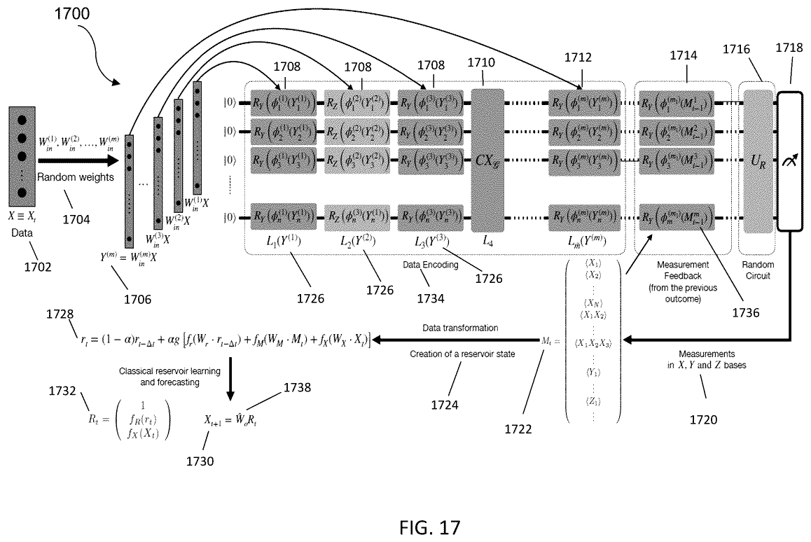

In step 202, a data input module 102 receives classical input data X at a time point t (Xₜ) and transforms the input data into a quantum-compatible format. This step allows the input data Xₜ be transformed into a format suitable for the quantum mechanics-based operations of qubits in a quantum computer. The data input module 102 may receive the input data at time t, denoted as Xₜ, (see FIG. 17, item 1702 for a representation of Xₜ) and apply a linear transformation using a random transformation matrix Wᵢₙ^{(j)} (further reference to FIG. 17, item 1704 for a depiction of Wᵢₙ^{(j)}). Matrix Wᵢₙ^{(j)} provides an initial transformation that prepares the classical data Xₜ for quantum processing.

The matrix in Wᵢₙ^{(j)} may have dimensions (dLⱼ,dᵢₙₚᵤₜ), where dLⱼ is the number of parameters that the layer Lⱼ can accommodate. For example, in a system with n qubits, if the layer consists of single-qubit X-rotations, then dLⱼ=n. The dimension dlᵢₙₚᵤₜ may correspond to the size of the input vector Xₜ. The elements of the transformation matrix Wᵢₙ^{(j)} may be generated at random, i.e. chosen based on a random distribution. Once generated, the matrix Wᵢₙ^{(j)} may remain unchanged throughout the entire training and prediction phases of computing process 200, which provides stability to the encoding process over time.

In implementations, for encoding layers that perform Fourier-type transformations, the structure of the transformation matrix Wᵢₙ^{(j)} can be non-random and predetermined, adhering to the requirements of the Fourier transform. To ensure the encoding process of data encoding module 104 is not affected by disproportionately large numerical values, which could lead to computational difficulties, the matrix Wᵢₙ^{(j)} may be normalized. This normalization may be performed by dividing the matrix by its largest singular value to condition the matrix for numerical stability. By using this form of normalization, the model ensures that the encoded quantum data maintains a scale conducive to quantum processing.

In step 204, a quantum data encoding module 104 may encode transformed data Yₜ^{(j)} into a quantum circuit via operations such as parameterization, feature mapping, and entangling gates.

See FIG. 17, item 1706 for a representation of Yₜ^{(j)}. In implementations, the quantum circuit may include a quantum data encoding module 104, a quantum feedback module 106, a random transformation module 108, and a quantum measurement module 110. In examples, the quantum data encoding module 104 may include multiple data encoding layers which are either parameterized or parameter-free.

### Parameterization

In step 204, transformed vectors Yₜ^{(j)} may be distributed across the quantum circuit in parametrized layers Lⱼ(Y^{(j)}). See FIG. 17, item 1726 for a representation of Lⱼ(Y^{(j)}). Each layer Lⱼ may correspond to a sequence of single-qubit rotation gates, denoted as Rₓ, R_{y} and R_{z}, which correspond to rotations around X, Y and Z-axes of a Bloch sphere, respectively. The rotations maybe parameterized by the elements of Y^{(j)}, facilitating the process of encoding the input data into quantum states of qubits.

To ensure the numerical stability of the quantum calculations, the weight matrices (denoted as Wᵢₙ) used to encode the input data into the quantum circuit may be normalized by their largest singular value. This normalization prevents excessively large values that could otherwise cause computational issues.

### Entanglement Gates

In implementations, the quantum circuit may also include parameter-free layers of Controlled-NOT (CNOT or CX) gates for creating entanglement between qubits.

Entanglement is a quantum mechanical resource that allows qubits to be correlated in ways that are not possible classically. Example entanglement operations may include Controlled-Phase, iSwap, fSim, and 2-qubit XY rotation gates. These quantum computations are essential for enabling the quantum circuit to capture correlations and perform computations that leverage quantum mechanics.

In implementations, the CX gates that provide entanglement between pairs of qubits do not require any external parameters to be set for their entangling operations. Instead, the CX gates act on pairs of qubits as defined by a connectivity graph G. The graph G determines which qubits are linked by CX gates, effectively mapping out the circuit's entanglement structure. The graph G may be chosen to match the hardware-specific topology of the quantum processor, which helps optimize the circuit for the physical qubit arrangement and minimizes the need for additional operations like SWAP gates. While SWAP gates may be used to virtually rearrange qubits that are not directly connected, they add complexity and can introduce errors. By adopting a connectivity graph G, the system 100 minimizes these issues, streamlining the process of qubit interaction.

The layers of the CX gates may be instrumental for generating entanglement within the quantum circuit. The generated entanglement allows the quantum circuit to explore a larger portion of the Hilbert space—the mathematical space that describes quantum states. With a more extensive exploration of this space, the quantum circuit can represent a more diverse set of solutions, giving it higher expressibility for the task at hand, such as pattern recognition or machine learning processing.

### Feature Mapping

Feature mapping may be employed to further transform data encoded parameters Yₜ^{(j)} into a form that can be used to set the parameters of different types of quantum gates. In examples, the feature mapping process may include applying feature maps, denoted as functions φₖ^{(j)}, which is used by the encoding module 104 to further transform the parameters Yₜ^{(j)} into quantum gate parameters. The feature map functions further enhance the representation of data Yₜ^{(j)} within a quantum state space.

### Measurement Feedback

After initial data encoding into the quantum circuit, in step 206, measurement feedback from a previous measurement vector is further encoded into the quantum circuit by a quantum feedback module 106. The quantum feedback module 106 may take measurement results from a previous a time-step (denoted as Mₜ₋₁) and encode them into the parameters of the quantum gates of the quantum circuit in the current time step. That is, the prior measurement results may be derived from the quantum circuit parameterized by a preceding iteration of the quantum computing process 200. This feedback encoding process may include adjusting the angles or other parameters of the quantum gates based on the values obtained from the previous measurements, effectively incorporating historical data into the current computational state of the circuit. This feedback mechanism is a form of temporal correlation, allowing the circuit to retain and utilize information from its previous state, which is essential for tasks that involve memory or prediction over time.

Since the number of measurements may not match the number of parameters required in a measurement feedback layer, a distribution mechanism may be employed. For example, single-qubit expectation values, e.g. e.g. [symbol] Xi [symbol] , may be employed to supplement a single-qubit rotation on i-th qubit, i.e. RY ( [symbol] Xi [symbol] )). For parameterized layers of the quantum circuit that are not fixed, there may be an extra step of parameter transformation following the feature map encoding approach.

This additional transformation introduces non-linearities that are essential for learning complex dynamics.

Similar to the quantum data encoding module 104, the feedback module 106 may further transform data encoded parameters (corresponding to the feedback measurements) using feature maps φₖ^{(j)} for enhancing representation of the parameters within the quantum state space.

In example embodiments, in step 208, the quantum circuit may be executed to generate an updated measurement vector following the encoding of measurement feedback. Here, an optional random transformation module 108 may be employed to output a quantum state configuration. This quantum state configuration is then further measured by a quantum measurement module 110 to generate an updated measurement vector. For example, the random transformation module 108 may be composed of a sequence of quantum gates that are initialized with random parameters. The random transformation module may include single-qubit gates that rotate the state of individual qubits around a Bloch sphere by random angles. These rotations change superposition states of qubits in an unpredictable manner. After the single-qubit rotations, a series of Controlled-NOT (CX) gates may be applied to create entanglement between pairs of qubits.

Following configuration, the output of the quantum circuit undergoes a measurement process by the measurement module 110. The quantum measurement module 110 may employ a measurement strategy that maximizes the efficiency of this process while also expanding the variety of distinguishable patterns, or “problem signatures,” that can be detected. To achieve this, each qubit across the three fundamental Pauli bases: X, Y, and Z may be measured. The Pauli X, Y, and Z measurements correspond to observing the qubits in different orientations, essentially providing different “views” of the qubit states. This measurement approach facilitates in the construction of a measurement vector that encapsulates both the individual qubit states-represented by single-qubit expectation values such as [symbol] X1 [symbol] , [symbol] X2 [symbol] , . . . , [symbol] Xn [symbol] , [symbol] Y1 [symbol] , . . . , [symbol] Yn [symbol] , [symbol] Z1 [symbol] , . . . , [symbol] Zn [symbol] —and the relational states between qubits, known as multi-qubit correlators. Further reference to FIG. 17, item 1722, for a representation of the measurement vector encapsulating individual qubit states.

These correlators may be determined by a predefined qubit connectivity graph, where the qubits are the graph's vertices, and their connections, or edges, specify which qubit pairs are involved in each correlator. For example, with a connectivity graph defined as G={(1,2),(2,3)}, the correlators may be measured as [symbol] X1X2 [symbol] and [symbol] X2X3 [symbol] , and analogous measurements for the Y and Z bases may be performed.

The results of the measurements are compiled into a measure vector Mₜ by quantum measurement module 110. This measurement vector may be a classical representation of the quantum state and may include:
Single-Qubit Expectation Values: These are the average measured values of a qubit's state when observed in the X, Y, or Z basis (denoted as [symbol] Xi [symbol] , [symbol] Yi [symbol] , and [symbol] Zi [symbol] for the i-th qubit). They provide information about the individual qubits' states.
Multi-Qubit Correlators: These are measurements that reflect the relationships between multiple qubits (denoted as [symbol] XiXj [symbol] , [symbol] XiXjXk [symbol] , etc.).

The quantum measurement module 110 may also feedback measurement outcomes from a previous measurement vector M^{t-1} to the quantum feedback module 106. The feedback module may then encode the measurement outcomes into its parameterized gates at the current time step.

Following the generating of an updated measurement vector Mₜ, in step 210, a reservoir state creation module 114 generates a reservoir state from a previous recurrent state and the input data.

The measurement vector is employed to establish the reservoir state, referred to as rₜ, using the following relationship: rₜ=(1−α)r_{t-Δt}+α[g(fᵣ(Wᵣ·r_{t-Δt})+f_{M}(Wₘ·Mₜ)+f_{X}(W_{X}·Xₜ))] (see item 1728 of FIG. 17 for a representation of the generated reservoir state).

In this formula, α is a value between 0 and 1 and is known as the leak rate. This rate modulates how much previous state information is maintained in the reservoir, balancing memory retention and the influence of new data. The functions fᵣ, f_{M}, and f_{X} are activation functions that introduce data transformation, enriching the system's ability to capture complex dynamics. The weight matrices Wᵣ, W_{M}, and W_{X} are random matrices that connect the reservoir state r, the measurement state M, and the input state X respectively. A global transformation function g(⋅) can also be applied, further allowing non-linear processing of the data.

The reservoir state equation encapsulates the step where the quantum measurement data is integrated into the reservoir state, thus injecting the system with valuable information from the quantum measurements and enabling non-linear processing. This equation is designed to be versatile, allowing for the contributions of each term to be adjusted or omitted. For example, if f_{M} is set to zero and both fᵣ and f_{X} are identity functions, the equation simplifies to a classical reservoir computing model.

Weight matrices Wᵣ, W_{M}, and W_{X} may be normalized using their largest singular value. This normalization may add robustness to the system by ensuring that the training and prediction operations are conducted within a numerically stable range.

At step 212, the process 200 may determine whether all input data have been processed. This decision point is pivotal for the flow of operations within the quantum reservoir computing system. If there is still unprocessed data, the system loops back to continue the transformation, encoding, and integration of this data into the quantum circuit. This iterative process ensures that each piece of input data is utilized to update the measurement vector and, by extension, the reservoir state. Once all input data have been processed, the process proceeds to the step 214, which involves performing ridge regression on the series of reservoir state vectors.

At step 214, following the measurements of quantum states and the transformation of data into classical information represented by the reservoir states rₜ, a classical processing module 116 engages in classical processing.

### Formation of Reservoir State Vector Rₜ:

The reservoir states rt, along with the input states Xₜ, may be combined to form a reservoir state vector Rt. This vector is constructed by appending the transformed reservoir state, f_{R}(rₜ), and a transformed version of the input state, h_{X}(Xₜ), to a unit value (e.g. 1). The unit value acts as a bias, similar to biases in artificial neural networks, which is essential for learning algorithms as it allows the model to fit the data better. See item 1732 of FIG. 17 for a representation of the generated reservoir state vector.

### Learning Procedure and Ridge Regression

In step 214, the assembled vector Rₜ may be used in a learning procedure based on ridge regression implemented by a learning and prediction module 118. Ridge regression is a variant of linear regression that includes regularization to prevent overfitting and improve the model's predictive accuracy.

The learning model may incorporate non-linear transformations, denoted by f_{R} and h_{X}, applied to the reservoir and input states, respectively, before they are used in the ridge regression. These non-linearities are crucial as they allow the model to capture more complex patterns in the data that linear methods might miss.

By introducing non-linear transformations, the model gains flexibility, enabling it to identify and leverage intricate non-linear relationships within the data. This capability significantly enhances the model's learning capacity, allowing for more precise and nuanced predictions.

In step 214, performing the ridge regression generates a set of readout parameters or readout weights Ŵₒ which can be used to make future predictions for the dynamical system.

In step 216, after successful completion of the ridge regression analysis where the readout parameters Ŵₒ are determined, the process 200 proceeds to generate new input data predictions. This is achieved by applying the readout parameters to the reservoir state vector Rₜ generated in the previous steps. The reservoir state vector, which encapsulates the processed information from both the quantum circuit and classical transformations, is now used in conjunction with the readout parameters to produce a prediction vector Xₜ₊₁. This vector represents the forecasted or predicted state of the system for the next time step (t+1).

The described quantum machine learning system 100 and process 200 emphasizes the use of quantum measurements as proxies for capturing relevant information, rather than solely relying on “physics-inspired” data like Hamiltonians in VQAs. This approach treats measurement operators as a hyperparameter, which may be chosen arbitrarily and incorporates randomness into reservoir creation. A technical achievement of this process 200 is its exploitation of the quantum system's computational power in combination with classical reservoir computing techniques. The design strategy provides an adaptable “Ansatz” for efficiently utilizing quantum hardware while effectively handling complex data representations.

In some embodiments, the process 200 may further employ a classical co-processor to receive classical output from the quantum circuit and apply post-processing to produce refined data, and repeating operations that produce classical output to gather statistics for post-processing refinement. In examples, the process 200 may employ the steps of repeating quantum circuit operations with each repetition compiled differently to enable post-processing suppression techniques and augmenting a quantum output with a classical co-processor for system enhancement based on accumulated statistics.

The system 100 and process 200 are distinguished by their use of measurements not just for their computable quantum attributes but also for their role in introducing non-linearity, critical for capturing complex data relationships.

Moreover, the approach maintains flexibility, allowing for the transformation of measurements to better fit the specific needs of the problem being addressed. This adaptability ensures the technique's applicability across a broad range of machine learning tasks, spanning from linear to highly non-linear problems, all while preserving computational efficiency and interpretability.

### EXPERIMENTAL RESULTS

The following section describes various experiments conducted to evaluate embodiments of the disclosure. Some of these experiments illustrate embodiments of the disclosure other than those discussed above.

This section details the application of the Hybrid Quantum-Classical Computing (HQRC) method to chaotic systems, focusing on the Lorenz63 model as the primary testing ground for the algorithm. To ensure a thorough assessment, the method is also applied to the double-scroll model-a three-dimensional chaotic system.

Simulations of quantum circuits are performed on classical computing frameworks to adjust hyperparameters effectively. Additionally, experiments are conducted using quantum processing units (QPUs), namely the 79-qubit Aspen-M-3 chip from Rigetti and the 8-qubit Lucy chip from Oxford Quantum Computing (OQC). These QPU experiments are selectively based on the most effective hyperparameter configurations identified in the simulation phase on classical computers.

For the enhancement of results from quantum processing, which is susceptible to noise, Clifford Data Regression (CDR) is applied as an error mitigation technique. This strategy is grounded in the research by Piotr Czarnik, Andrew Arrasmith, Patrick J. Coles, and Lukasz Cincio, “Error mitigation with Clifford quantum circuit data,” in Quantum 5, 592 (2021), and further by Angus Lowe, Max Hunter Gordon, Piotr Czarnik, Andrew Arrasmith, Patrick J. Coles, and Lukasz Cincio, in “Unified approach to data-driven quantum error mitigation,” published in Physical Review Research. These cited works underpin the methodology for improving the fidelity of quantum computations in the presence of operational noise.

It should be emphasized that the experiments and outcomes presented herein serve as exemplary illustrations and were conducted under particular conditions employing one or more specific embodiments. Consequently, neither the described experiments nor their findings should be construed as restricting the breadth of the disclosure encompassed by the present patent document.

### A. Metrics Section

The Valid Prediction Time (VPT) is the principal metric used to assess the quality of the network's predictions, as defined by Vlachas et al. in “Backpropagation algorithms and reservoir computing in recurrent neural networks for the forecasting of complex spatiotemporal dynamics” (2020), arXiv:1910.05266 [eess.SP], and Platt et al. in “A systematic exploration of reservoir computing for forecasting complex spatiotemporal dynamics” (2022), arXiv:2201.08910 [cs.NE]. The VPT is the juncture at which the model's predicted output diverges beyond a specified threshold from the actual data, measured by the root mean square error (RMSE):

$$RMSE ( t ) = \sqrt{\frac{1}{D} {\sum }_{i = 1}^{D} {( \frac{{\tilde{y}}_{i} ( t ) - {y}_{i} ( t )}{{σ}_{i}} )}^{2}} \geq ε ,$$

where \tilde{y}ᵢ(t), yi(t) are i-th component at time t of predictions and ground truth, respectively, σᵢ is the i-th component of standard deviation of the true data and D is the dimensionality of the problem (e.g. for Lorenz63 and double-scroll D=3). In our analysis, we select the threshold ε=0.3, following a systematic review of classical reservoir computing in Platt et al.

In the case of chaotic systems, it is clear that indefinite forecasting cannot be expected. Therefore, an equally important metric for benchmarking these systems is long-term attractor prediction, which means that the system stays in its basins of attractions, while potentially deviating from the correct component-wise predictions. Hence, in the analysis the closeness of predicted and ground truth attractors is investigated. Additionally, Poincare' return maps, as described by Pathak et al. in “Using machine learning to replicate chaotic attractors and calculate Lyapunov exponents from data,” Chaos: An Interdisciplinary Journal of Nonlinear Science 27 (2017), doi: 10.1063/1.5010300, are used. This method plots sequential local maxima of time series data [z₁, z₂, . . . , zₘ] against each other [zᵢ, zᵢ₊₁] to order all local maxima of the predicted and actual time series (for which longer simulations are used).

### B. Classical Simulations

The HQRC framework offers flexibility in selecting the number of qubits, the depth of circuits, and the quantity of measurements, which correspond to the reservoir's size. These selections can be tailored to allow simulation on classical computers. This section analyzes results showing that the framework possesses sufficient expressibility for predicting the behavior of chaotic systems. The predictive performance is comparable to state-of-the-art results achieved by classical reservoir computing.

### 1. Lorenz63

Lorenz63, as described by Edward N Lorenz, “Deterministic nonperiodic flow,” Journal of atmospheric sciences 20, 130-141 (1963), is a standard benchmark for classical RC, as it is well-studied chaotic model. The dynamics of the system is governed by the following set of differential equations:

$$\begin{matrix}\frac{dx ( t )}{dt} = 10 [ y ( t ) - x ( t ) ] , \\ \frac{dy ( t )}{dt} = x ( t ) [ 28 - z ( t ) ] - y ( t ) , \\ \frac{dz ( t )}{dt} = x ( t ) y ( t ) - \frac{8 z ( t )}{3} ,\end{matrix}$$

where coefficients were fixed to match the commonly used value in the literature (as described in Daniel J. Gauthier, Erik Bollt, Aaron Griffith, and Wendson A. S. Barbosa, “Next generation reservoir computing,” Nature Communications 12 (2021), 10.1038/s41467-021-25801-2.). These equations are analogous to a simplified weather model of atmospheric convection that experience uniform heating and cooling from below and above, respectively.

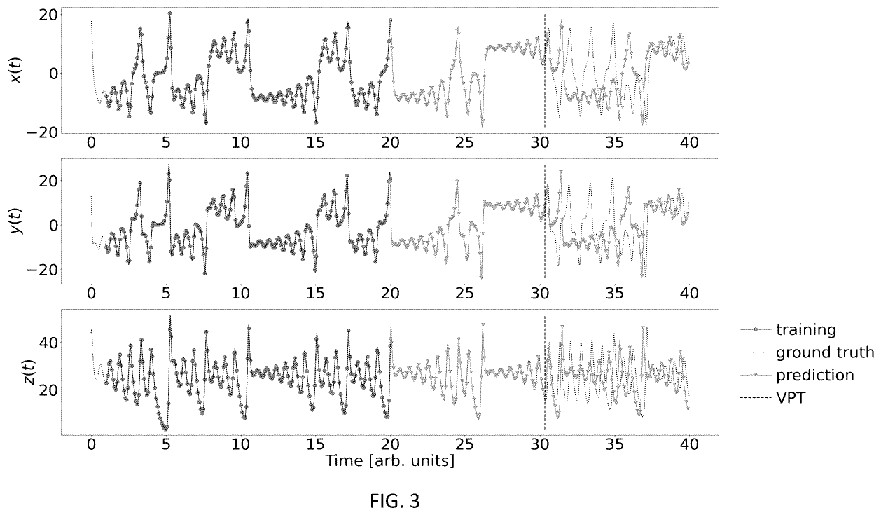

FIG. 3 illustrates simulated outcomes for a Lorenz63 chaotic system using a Hybrid Quantum-Classical Reservoir Computing (HQRC), according to an embodiment herein.

The Lorenz63 system, a three-dimensional system known for its chaotic solutions, is specified with initial conditions for the variables x, y, and z. The dynamics of the system are discretized into time steps of dt=0.01, and the simulation involves parameters such as a leak rate of 0.7 and a very small regularization term of 10⁻⁸, which are consistent across other related results in the document. For the experiment described in FIG. 3, the quantum reservoir computing model (HQRC) is trained over 2000-time steps, equating to a simulated time of t=20. An additional 2000-time steps are used for making predictions about the system's future states. The Variational Power Transfer (VPT) achieved is 10.32. This HQRC model is run on a classical computer using a noiseless simulation approach, where true expectation values are obtained from an ideal quantum circuit. It was identified that, in case of Lorenz63, substantially better results are obtained for reservoir Ansãtze without the measurement feedback layers and a random circuit, as the addition of the latter may lead to low quality forecasting. The outcomes are collected from a noiseless simulator without shot-noise meaning the expectation values have been calculated from the wave function, instead of sampled with a finite number of shots, as in the case of QPU results.

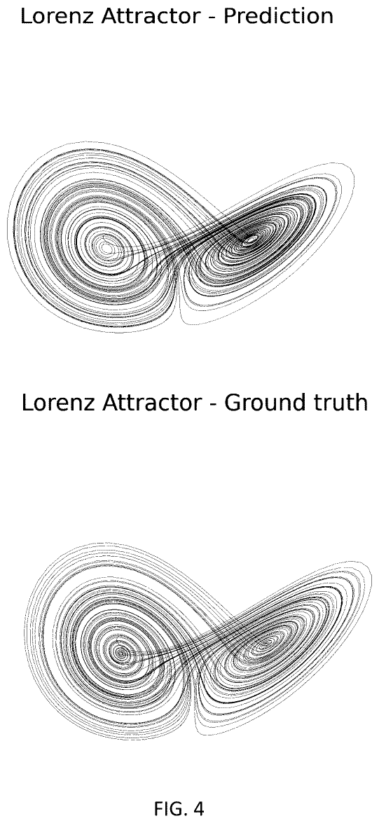

FIG. 4 illustrates the Lorenz63 attractor's position over time, demonstrating the HQRC's system's ability to accurately reconstruct long-term qualitative behaviour, according to an embodiment herein.

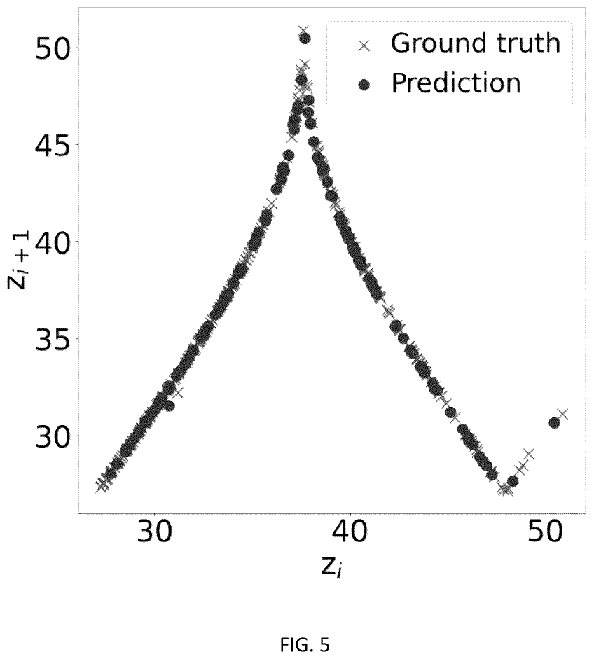

FIG. 5 illustrates a Poincaré return map for the Lorenz63 chaotic system, illustrating the orderly oscillatory patterns amidst component-wise divergence after around 30-time units, in accordance with an embodiment presented herein.

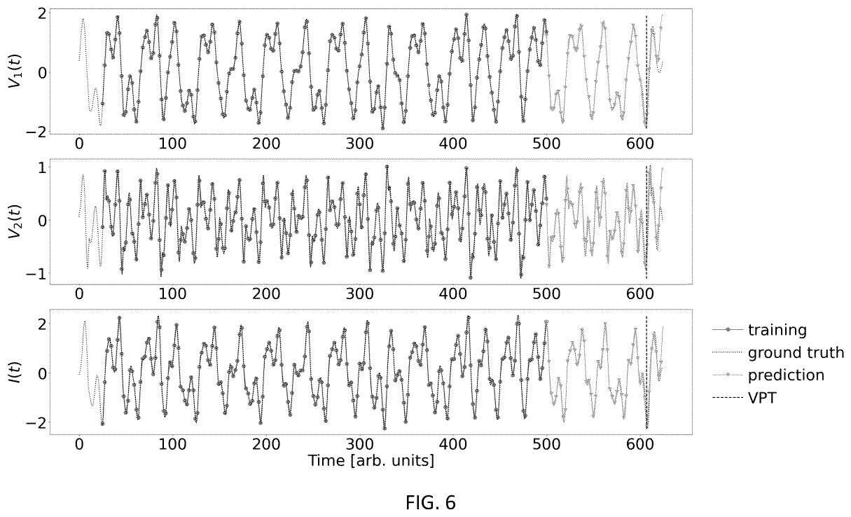

FIGS. 5 and 6 adhere to the same parameters as those defined in FIG. 3, with the sole distinction being that the prediction phase extends over 10,000 steps. This extended sequence allows for a comprehensive observation of the system's long-term dynamics.

The benchmarked Lorenz63 system comprises of total 19 data encoding layers, from which there are 5 parameter-free layers of CX network with underlying graph having connectivity of a ring. Additionally, the remaining 14 layers are single qubit rotations.

In the setup, since X, Y, Z measurements to construct the measurement vector composed of single qubit expectation values, and two-qubit and three-qubit correlators between qubits from the fully connected graph are used, reservoirs of 127 size are utilized. Despite the small size, a VPT of 10.32 is obtained, which is substantially better than the state-of-the-art classical approaches with comparable reservoir sizes. However, the reservoir size is not the only important property of these algorithms, whether it is a classical or quantum one, although it is one of the computationally demanding subroutines that scales as O(n³), where n is the reservoir size.

The presented results provide compelling evidence to support that the HQRC approach is a viable quantum alternative to the classical RC approaches. In particular, the standard RC approach, can be extremely sensitive to various hyperparameters (reservoir size, training length, etc.). As the proposed method has multiple hyperparameters to select (number and type of layers, type of feature maps, measurement correlators, etc.), a hyperparameter sensitivity is observed as well, however even though the variations between performance can fluctuate, the forecasts rarely diverge from stable solution, which is not the case for the classical RC.

### 2. Double-Scroll

Another popular benchmark is based on the dynamics of a double-scroll electronic circuit given by:

$$\begin{matrix}\frac{{dV}_{1} ( t )}{dt} = \frac{{V}_{1} ( t )}{{R}_{1}} - \frac{Δ V ( t )}{{R}_{2}} - 2 {I}_{r} sinh ( β Δ V ( t ) ) , \\ \frac{{dV}_{2} ( t )}{dt} = \frac{Δ V ( t )}{{R}_{2}} + 2 {I}_{r} sinh ( β Δ V ( t ) ) - I ( t ) , \\ \frac{dI ( t )}{dt} = {V}_{2} ( t ) - {R}_{4} I ( t ) ,\end{matrix}$$

in dimensionless form, with ΔV(t)=V₁(t) V₂(t). The above parameters are fixed to: R₁=1.2, R2=3.44, R4=0.193, β=11.6 and Ir=2.25×10-5. Inspired by the Ansatz incarnation for Lorenz63 model, a restricted search for decent hyper-parameters was performed.

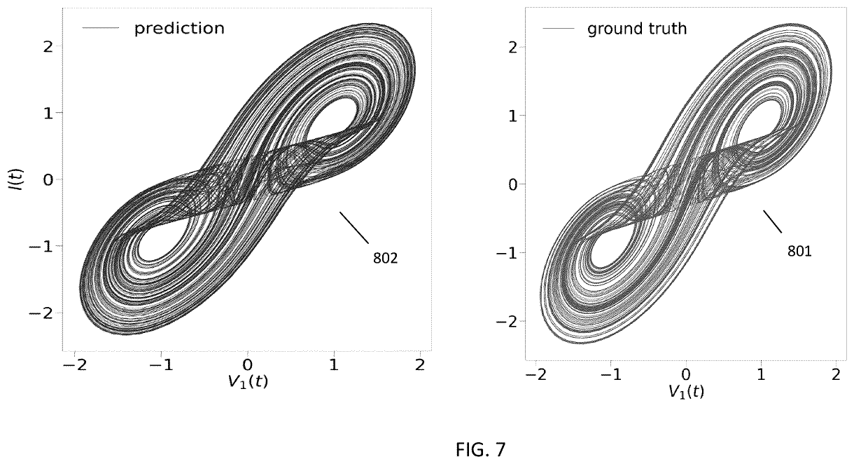

FIG. 6 illustrates simulated outcomes for a double-scroll system using the HQRC system with 8 qubits and a reservoir size of 271, according to an embodiment herein. FIG. 6 illustrates training outcomes overlapping with the ground truth in simulations using time increments of dt=0.25 of a time unit and subsequent prediction steps beginning to diverge after approximately 100-time units, with a Validation Prediction Time (VPT) of 107.5, which is competitive with state-of-the-art results. FIG. 7 illustrates reconstructed long-term behaviour based on the attractor for a double-scroll system using an 8-qubit HQRC configuration, according to an embodiment herein. FIG. 7 depicts the same experimental arrangement as presented in FIG. 6, with the extension being a protracted prediction phase encompassing 10,000-time steps.

### C. QPU Simulations

Additionally, run proof-of-concept tests of HQRC algorithm on two superconducting platforms: Rigetti Aspen-M-3 chip with 79 qubits, and Lucy an 8-qubit chip from OQC was performed. As currently available devices suffer from various sources of imperfection, observing lower quality results may be expected as compared to the simulated noiseless results above. In particular, the first and device-independent errors stem from the limited number of measurements taken to extract expectation value, what is known as shot noise. This seemingly minuscule feature of probabilistic interpretation has, indeed, substantial influence on prediction power in chaotic systems, where each decimal place in numerical simulation can result in discrepancies between the ground truth and forecasts.

The premise of RS stems from underlying randomness, i.e., that coherent and incoherent noise present in real devices may have neutral or negligible influence on the performance. As this is the case for weak uncorrelated noise (e.g. white noise) in classical RC, this is not the case for the quantum devices, as noise can exhibit both spatial and temporal correlations (cross-talk, 1/f, etc.). This means that noise impacts differently on every single iteration, making it harder to learn in the ridge regression procedure. Even though the training subroutines perfectly matches the ground truth, forecasts are quickly diverging, as correlated and non-static errors hamper the performance.

### 1. Rigetti Aspen M-3

In case of Aspen M-3 chip, that hosts 79 qubits, the algorithm's implementation can be tested in parallel, which means, that the Ansatz is implemented on three spatially separated regions of the chip, in such a way, that each region performs measurement of all of their qubits in different bases (i.e. X, Y and Z). This, for fault-tolerant devices, would generate exactly the same results, as running three separate circuits on the same qubits. However, as qubits currently exhibit varying degree of errors (e.g. different calibrations lead to different fidelity values across the qubit lattice), higher degree of fluctuations may be expected. In the experiments Ansatz with 8, 16 and 23 qubits were used, which translates to using simultaneously 24, 48 and 69 qubits, respectively, due to parallel implementation. The results substantially deviate from theoretical noiseless predictions, as well as from shot noise only simulations.

In order to improve results, to be closer to the theoretical expectations, a Clifford Data Regression (CDR) was implemented—an error mitigation strategy that aims to adjust expectation values based on a linear regression between noiseless and noisy results. In the standard CDR approach, Clifford circuits are utilized, which are efficiently simulated.

In the testing, the Clifford condition was relaxed, which for the tested Ansatz was equivalent to setting all rotation angles to 0 or π. Even though, this is not a designed implementation of the CDR, we used an all angle permitted strategy to demonstrate feasibility of the technique, as the 8-qubit circuit can be simulated on a personal computer.

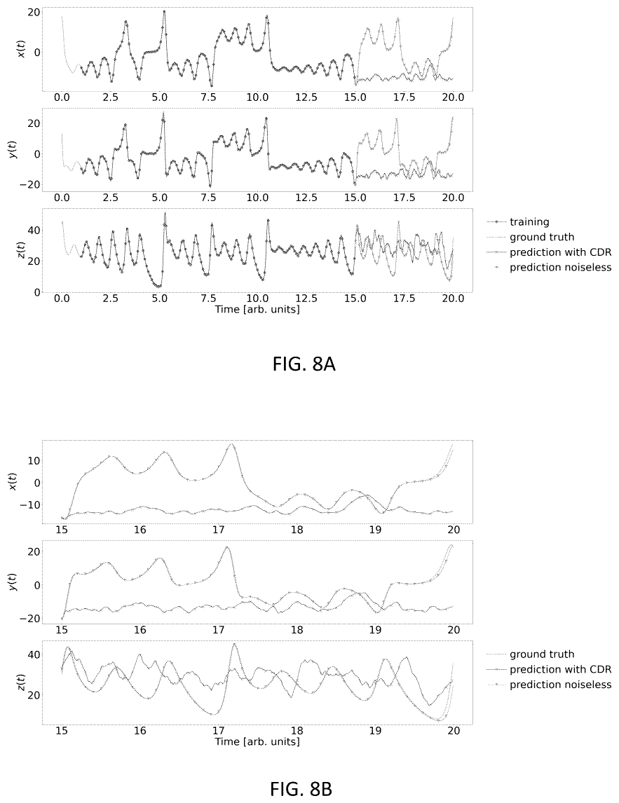

FIGS. 8A and 8B are graphical representations of the performance of the HQRC algorithm implemented on an Aspen M-3 chip during training and after training when making predictions, using Clifford Data Regression (CDR), according to an embodiment herein.

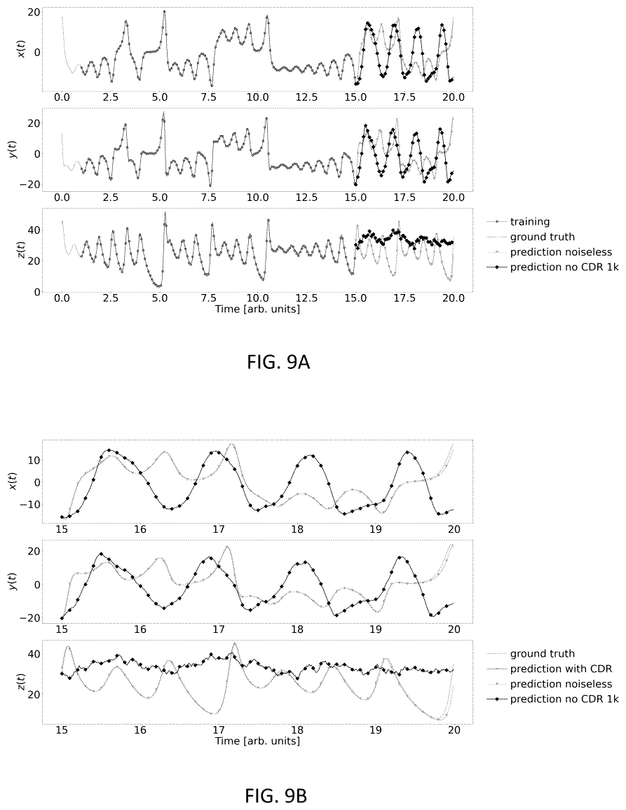

FIGS. 9A and 9B are graphical representations of the performance of the HQRC algorithm implemented on an Aspen M-3 chip during training and after training when making predictions, without using CDR with 1,000 shots, according to an embodiment herein.

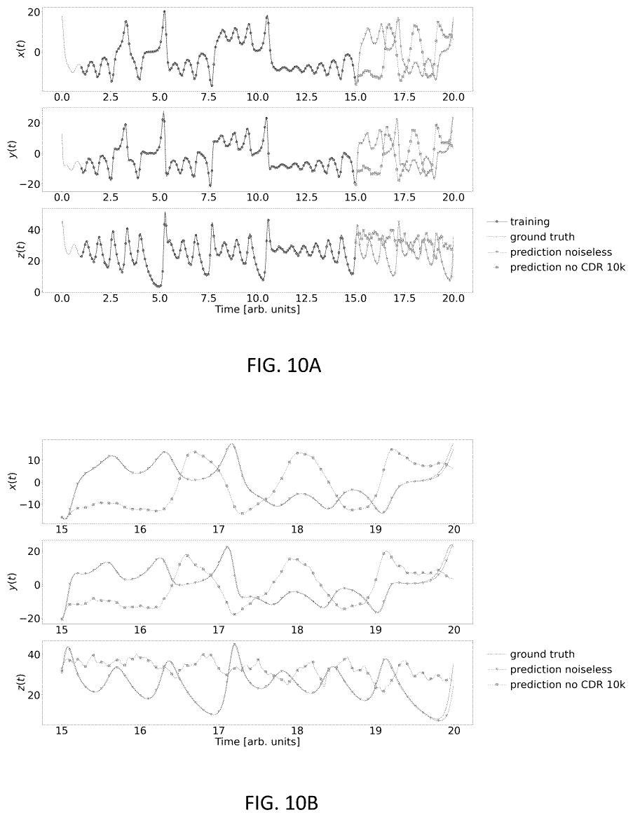

FIGS. 10A and 10B are graphical representations of the performance of the HQRC algorithm implemented on an Aspen M-3 chip during training and after training when making predictions, without using CDR with 10,000 shots, according to an embodiment herein.

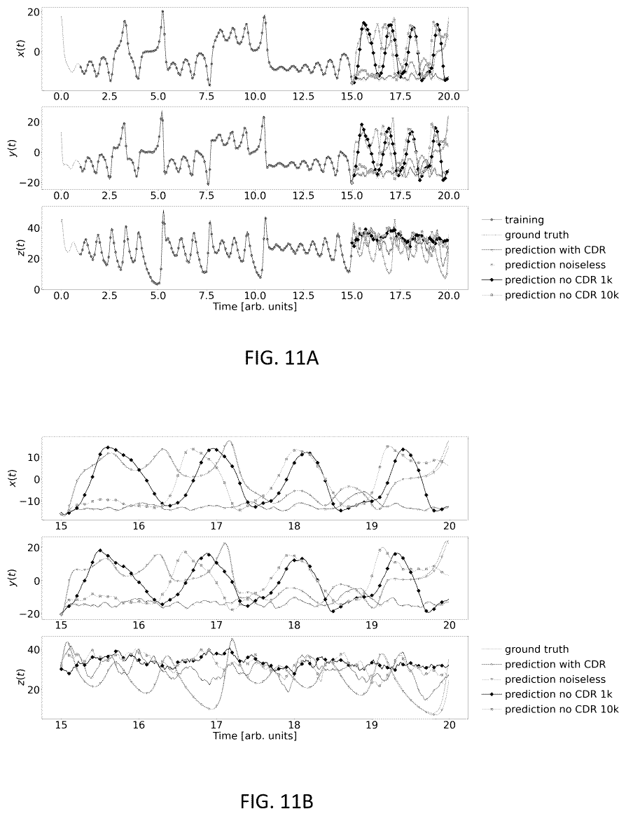

FIGS. 11A and 11B are graphical representations of the collective performance of the HQRC algorithm implemented on an Aspen M-3 chip during training and after training when making predictions using CDR, as well as without using CDR with 1,000 shots and 10,000 shots, according to an embodiment herein.

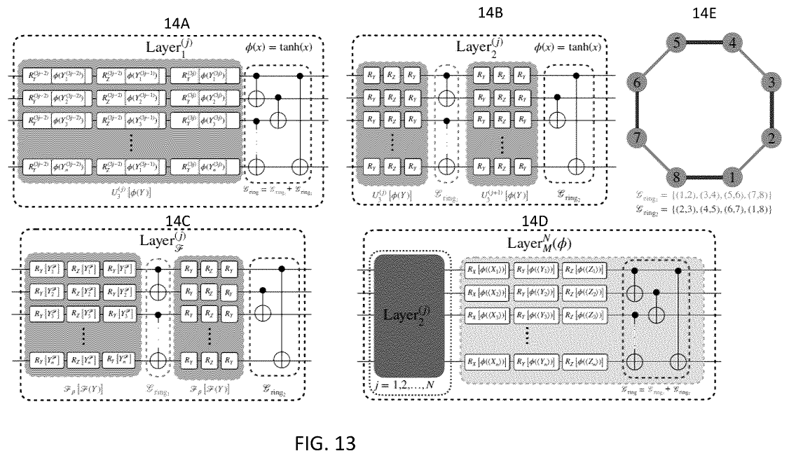

FIG. 11, part A, and its corresponding prediction-focused part B, consolidate the outcomes from FIGS. 8, 9, and 10. These results originate from an 8-qubit quantum circuit incorporating six layers of the Layer_1 type shown in FIG. 13, characterized by the transformation q(x)=arcsin(tanh(x)), and executed on the Aspen M-3 chip. The variations in the setups are distinguished by their approach to prediction and data sampling:

Prediction with CDR: This setup employs Clifford Data Regression (CDR) for error mitigation, utilizing a series of 20 circuits in the HQRC configuration to ascertain fitting coefficients within the CDR methodology. Additionally, for approximating the measurement vector, 10,000 quantum circuit runs, or ‘shots’, are used.

Prediction no CDR 1 k and 10 k: These setups forgo the CDR strategy and are identical except for the number of shots used for gathering data—1,000 and 10,000 shots, respectively.

Prediction noiseless: This refers to a classical simulation that serves as a baseline for comparison, providing exact expectation values for the measurement vector, thereby assuming an ideal scenario without quantum noise.

The presented proof-of-concept findings compare different implementations of the same Ansatz. In a noiseless simulation that delivers exact expectation values, a Valid Prediction Time (VPT) of 4.82 is achieved. However, Quantum Processing Unit (QPU) runs fall short of this benchmark. They attain a VPT of 0.04 when utilizing 1,000 shots with Clifford Data Regression (CDR) and 10,000 shots without CDR. The VPT further declines to 0.01 for the configuration without CDR at 1,000 shots. These results highlight the discrepancy between ideal simulations and actual QPU performance under varying conditions.

### 2. OQC Lucy 8Q

A similar setup on 8-qubit chip provided by Oxford Quantum Circuits (OQC) was tested. In that case, the QPU runs are required to be run sequentially for different measurement bases, as the chip's architecture is insufficient to accommodate parallel implementation. Similarly, to the results from Aspen M-3, we observe deviations from the theoretical predictions.

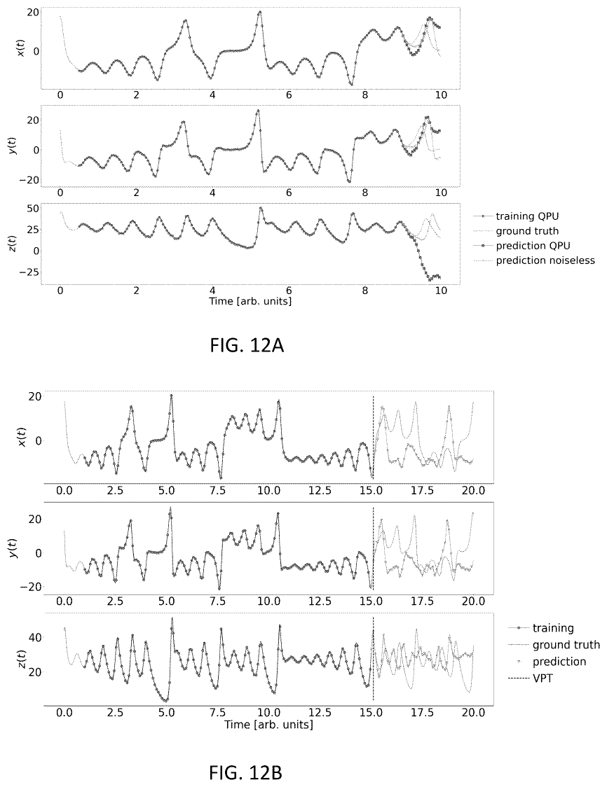

FIG. 12A illustrates the performance of the HQRC algorithm implemented on an 8-quit chip provided by Oxford Quantum Circuits (OQC) as compared to implemented on a quantum simulator, according to an embodiment herein. Measurement protocols include single, two, and three-qubit correlators, with data extracted from 4,000 shots. The circuit operates with consistent global hyperparameters such as leak rate and initial state across training, which encompasses 900-time steps, and prediction, which covers 100-time steps with a timestep dt of 0.01.

FIG. 12B illustrates an extended performance evaluation of the HORC algorithm when executed on an 8-qubit chip from Oxford Quantum Circuits (OQC). This iteration uses a training regime consisting of 1,500 training steps, followed by a prediction phase of 500 steps. Measurement protocols include only single and 2-qubit correlators. The measurement protocols for this experiment are restricted to single and 2-qubit correlators, even as the number of shots has been increased, which suggests a more detailed data acquisition process. A Validation Time Prediction (VPT) parameter is set at 0.1.

### Tested Layers

FIG. 13 illustrates the main layer types utilized for benchmarking the Lorenz63 system, illustrating quantum circuit designs with varying configurations of Ry and Rz gates and entanglement patterns across multiple qubits, as well as the specific entanglement pairs within two distinct ring groupings, according to an embodiment herein. The configurations include different combinations of Ry and Rz rotation gates, controlled NOT gates (CX), and entanglement strategies across qubits. Specifically, it details four main layer types, each with unique gate arrangements and entanglement pairings, as indicated by the corresponding graph structures. These layers are critical for evaluating the quantum system's dynamics and performance in simulations.

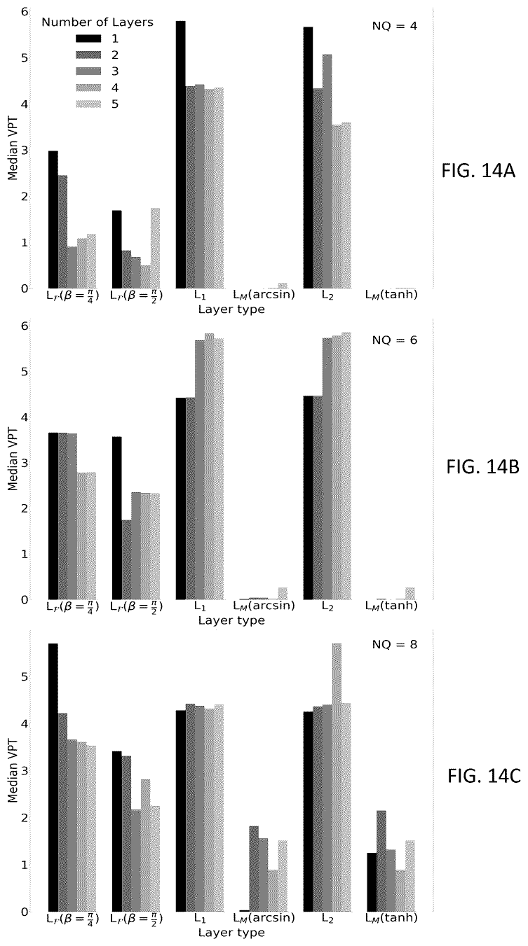

FIGS. 14A, 14B, and 14C illustrate a statistical compilation for the Lorenz63 problem demonstrating the performance impact of different quantum circuit layer types across systems, according to an embodiment herein.

FIG. 14 provides three bar graphs (A, B, and C) that summarize the median Valid Prediction Time (VPT) for classical simulations of the Lorenz63 system, performed without noise and based on exact expectation values. The simulations were conducted with 10 random matrix initializations. The layers utilized, as detailed in FIG. 13, incorporate various quantum gate configurations and entanglement patterns. The graphs illustrate the VPT across systems with 4, 6, and 8 qubits, revealing how the median VPT is influenced by the circuit layer type, number of layers, and number of qubits.

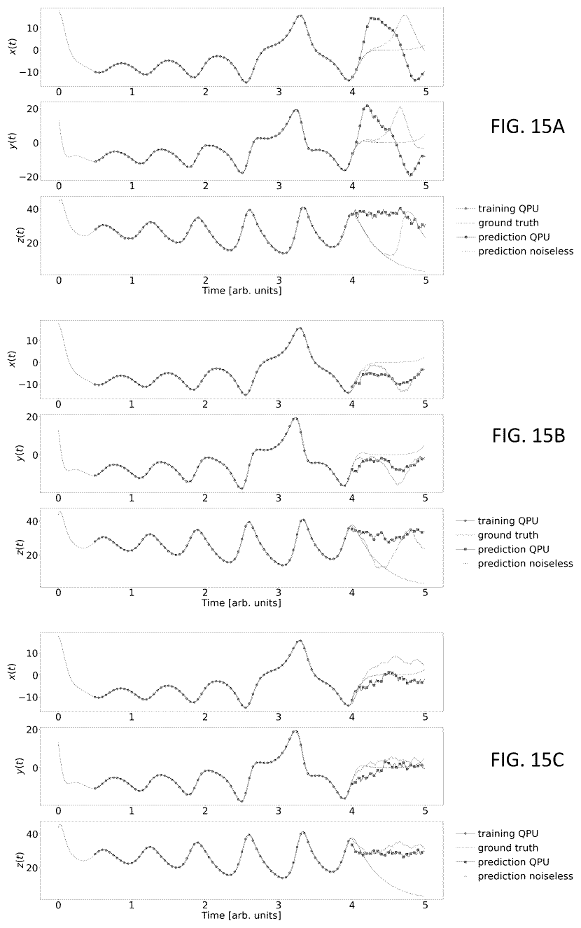

FIGS. 15A, 15B, and 15C illustrate the performance of the HQRC algorithm on a Rigetti Aspen M-3 chip using 8, 16, and 23 qubits respectively, according to an embodiment herein.

FIG. 15 presents the experimental results from a Rigetti Aspen M-3 quantum computer for systems of 8 (FIG. 15A), 16 (FIG. 15B), and 23 (FIG. 15C) qubits, comparing the GPU-based training predictions and noiseless theoretical predictions against the actual quantum measurements. These results are based on 1,000 shots, capturing single, two, and three-qubit correlations. The 8 qubit experiments used a complex sequence of rotational and entangling gates with a full ring graph connectivity, while the 16 and 23 qubit setups followed a similar but unspecified gate structure, all employing a hyperbolic tangent activation function in the rotations. The experiments were conducted in parallel across three regions of the quantum chip to extract different expectation values in the X, Y, and Z measurement bases.

### Feature Maps Used in Experiments:

In the experiments described, three distinct methods of feature map encodings were used:
1. Arc cosine (arccos) and arc sine (arcsin) functions were employed to emulate the Chebyshev polynomials when combined with Ry (rotation around the y-axis) gates, but these functions were also applied in conjunction with other types of quantum rotations.
2. The hyperbolic tangent (tanh) function was integrated as a standard machine learning activation function within the quantum circuit, allowing for non-linear transformations within the quantum domain.
3. Fourier encoding was used to preprocess the input data; this involves scaling the data by integer multiples of 2π, introducing a periodic structure to the data. Variations on this method were explored, including a “half-fourier” encoding that scales the input data by xkπ, where x is the data point and k is an integer multiplier, to adjust the frequency and phase of the encoding. It can be seen that the HQRC, has been tested on chaotic systems, which are typically a good fit for RC methods. HQRC shows promise in making short-term predictions and capturing the long-term behaviour of chaotic systems with lower-dimensional reservoir states than classical RC. Unlike traditional RC, HQRC offers a modular structure that allows for easy adjustment of multiple hyperparameters, impacting performance differently. HQRC's robustness to hyperparameter changes is such that even random configurations do not yield divergent results, unlike classical RC that may fail with low-dimensional states. This suggests that while there is variability in performance across different setups, HQRC consistently provides stable predictions.

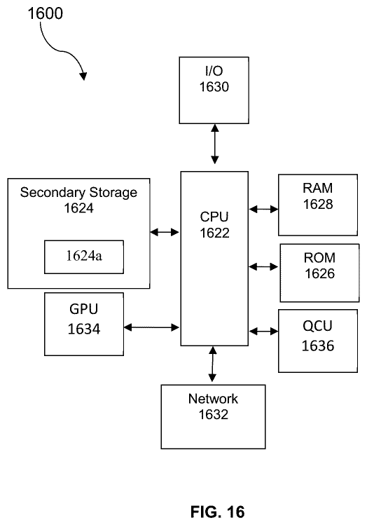

FIG. 16 depicts a schematic representation of a computing device 1600, designed to operate with both classical and quantum computing processes of the hybrid quantum computing system 100, in accordance with the embodiments of the systems and methods disclosed herein. The device comprises a central processing unit (CPU) 1622, which interfaces with various data storage and memory components: secondary storage 1624, read-only memory (ROM) 1626, and random-access memory (RAM) 1628.

Within this configuration, a Quantum Computing Unit (QCU) 1636 is integrated. The QCU 1636 utilizes quantum mechanical phenomena to enhance computation. It is engineered to execute algorithms that are particularly suitable for quantum computation, such as those involving large-scale number factorization, quantum simulations, and specific optimization problems, enabling computational performance that exceeds the capabilities of a standalone CPU.

The secondary storage 1624 may include a dedicated sector 1624a containing instructions executable by both the CPU 1622 and the QCU 1636. These instructions enable the device 1600 to perform operations that may be optimized through quantum computing.

The ROM 1626 stores immutable code essential for an initial booting process and routine operations of the computing device 1600. The RAM 1628 provides volatile memory for immediate access to data by the CPU 1622 and the QCU 1636 during active tasks.

Peripheral devices are managed through input/output (I/O) interfaces 1630, while network connectivity is enabled via a network interface 1632. A graphics processing unit (GPU) 1634 is present to handle parallel processing tasks, which may be separate from or integrated with quantum computing processes.

The CPU 1622, as the primary processor for general computing tasks, is responsible for executing sequential operations and handling a variety of computational processes in the classical domain. It manages routine tasks with high efficiency and interfaces with the system's memory, including RAM 1628 and ROM 1626, for data storage and retrieval.

Within this dual-capability system, the CPU 1622 often acts as a coordinator, determining when to engage the QCU 1636 based on the computational requirements. For quantum-suitable tasks, the CPU 1622 prepares and relays data to the QCU 1636, which then processes this information utilizing its quantum computing power. After the QCU 1636 completes the quantum processing, it can transmit the results back to the CPU 1622, which may perform additional classical processing or output the results.

The collaboration between the CPU 1622 and the QCU 1636 effectively expands the device's 1600 computational range, enabling it to switch between classical and quantum operations. This ensures that the device 1600 utilizes the most efficient processing method available, whether that be the classical computation provided by the CPU 1622 or the quantum processing offered by the QCU 1636.

Although the computing device 1600 is described with reference to a single computer, it should be appreciated that the computing device may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computing device 1600 to provide the functionality of a number of servers that is not directly bound to the number of computers in the computing device 1600. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third-party provider.

Additional components, such as one or more application specific integrated circuits, neuromorphic computing units, field programmable gate arrays, or other electronic or photonic processing components can also be included and used in conjunction with or in place of the processor 1622 to perform processing operations. The processing operations can include machine learning operations, other operations supporting the machine learning operations, or a combination thereof.

FIG. 17 illustrates a schematic representation of a hybrid quantum-classical computing system 1700, according to an embodiment herein.

In an example embodiment, the hybrid quantum-classical computing system 1700 is a predictive model for forecasting future states corresponding to a time-dependent dynamical system.

In the example embodiment, time dependent input data 1702 may be transformed using fixed transformation matrices 1704 to create transformed data 1706 corresponding to vectors of data-encoded parameters. The transformed data 1706 may be encoded into a quantum circuit 1734 by performing a multiple sets of quantum operations 1726. The quantum circuit 1734 includes multiple encoding layers 1708, an entanglement layer 1710, feedback layers 1712 and 1714, and a random transformation layer 1716. The multiple sets of quantum operations 1726 include one or a combination of one or more of: single-qubit rotations around at least one of the X, Y and Z-axes, controlled-phase gate operation, fSim gate operation, or 2-qubit XY rotation. The entanglement layer 1710 may correspond to Controlled NOT (CNOT) gates, representing CNOT operations applied without parameters. The entanglement layer 1710 may be used to entangle qubits according to a specific graph G, creating quantum correlations between the qubits.

One or more of the quantum operations 1726 may be executed to encode a measurement feedback from a previous measurement vector 1736 into the quantum circuit 1734. The layers take the measurement feedback from a previous time-step (t-1) and encode them into parameterized gates for the current time step. This step allows the system 1700 to have a form of memory, as measured output of the quantum circuit 1734 is fed back into the system.

The random transformation layer 1716 may include random quantum gates (e.g. single-quit rotations followed by a network of Controlled NOT gates) which are used to output a quantum state configuration. The quantum state configuration may be measured by a quantum measurement module 1718 for outputting measurements in X, Y, Z bases 1720 in order to generate an updated measurement vector 1722. The updated measurement vector 1722 may include single-qubit expectation values and multi-qubit correlators.

### Classical Processing and Ridge Regression

Following generating of the updated measurement vector 1722, a reservoir state 1728 is generated based on the updated measurement vector 1722, a previous reservoir state, and the input data 1702. The system 1700 then determines if additional time dependent input data 1702 needs processing.

Once all the time dependent input data 1702 is processed, a reservoir state vector 1732 is then generated based on a set of the generated reservoir states 1728, the input data 1702, and a bias term. In the example embodiment, the process of generating the reservoir state vector 1732 may include non-linear transformations of the reservoir state 1728 and time-dependent input data 1702.

A ridge regression procedure is then applied to a series of the generated reservoir state vectors 1732 to determine a set of readout parameters 1738. Predictions 1730 of a future state of the dynamical system are generated based on the readout parameters 1738 and the reservoir state vectors 1732.

The technical solution detailed in present disclosure may be embodied in the form of a computer program product. The computer program product may be stored in a non-volatile or non-transitory storage medium, which can be a compact disk read-only memory, USB flash disk, or a removable hard disk. The computer program product includes a number of instructions that enable a computer device (personal computer, server, or network device) to execute the methods provided in the embodiments described herein. For example, such an execution may correspond to a simulation of the logical operations, including the training and aggregation of model updates in the federated learning process, as described herein. The software product may additionally or alternatively include number of instructions that enable the computing device 1600 to execute operations for configuring or programming a digital logic apparatus in accordance with embodiments of the present invention.

By programming and/or loading executable instructions onto the computing device, at least one of the CPU 1622, the RAM 1628, and the ROM 1626 are changed, transforming the computing device in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

It will be appreciated to those skilled in the art that the preceding examples and embodiments are exemplary and not limiting to the scope of the present disclosure. Whilst the foregoing description has described exemplary embodiments, it will be understood by those skilled in the art that many variations of the embodiment can be made within the scope and spirit of the present invention. It shall be noted that elements of any claims may be arranged differently including have multiple dependencies, configurations and combinations.

1. A hybrid quantum-classical computing method comprising:
receiving time dependent input data of a dynamical system;
transforming a first element of the input data using a plurality of transformation matrices to obtain a set of transformed data;
encoding the transformed data into a quantum circuit by performing a first set of quantum operations, wherein the quantum circuit comprises a plurality of layers, wherein the layers include data encoding layers, feedback layers, and a random transformation layer;
encoding a measurement feedback from a previous measurement vector into the quantum circuit by performing a second set of quantum operations;
operating the quantum circuit to generate an updated measurement vector; and
generating a reservoir state based on the updated measurement vector, a previous reservoir state and the input data.

2. The hybrid quantum-classical computing method of claim 1, wherein the method further comprises determining whether additional input data is to be processed and forming a reservoir state vector based on one or more of the generated reservoir states, input data, and a bias term.

3. The hybrid quantum-classical computing method of claim 2, wherein the method further comprises applying a ridge regression procedure to a series of the formed reservoir state vectors to determine a plurality of readout parameters.

4. The hybrid quantum-classical computing method of claim 3, wherein the method further comprises generating predictions of a future state of the dynamical system based on the readout parameters and the reservoir state vector.

5. The hybrid quantum-classical computing method of claim 1, wherein the method further comprises using the quantum circuit and a trained classical processing module to generate predictions of a future state of the dynamical system, wherein the classical processing module receives as input non-linear transformations of the reservoir state and non-linear transformations of the time dependent input data.

6. The hybrid quantum-classical computing method of claim 1, wherein the method further comprises initiating entanglement among a plurality of qubits of the quantum circuit in the data encoding layers.

7. The hybrid quantum-classical computing method of claim 1, wherein each of the plurality of transformation matrices comprise a plurality of fixed transformation matrices, which remain invariant during both training and prediction phases of the computing process.

8. The hybrid quantum-classical computing method of claim 1, wherein each of the plurality of transformation matrices comprise a random weight matrix or a Fourier-like matrix; and the set of transformed data are generated by performing functional transformations over the first element of the input data.

9. The hybrid quantum-classical computing method of claim 1, wherein each of the first and second set of quantum operations comprise one or a combination of one or more of:
single-qubit rotations around at least one of X, Y and Z-axes;
Controlled-Phase gate operation; or
fSim gate operation; or
2-qubit XY rotation.

10. The hybrid quantum-classical computing method of claim 1, wherein encoding the transformed data and encoding the measurement feedback includes a use of feature map functions for transforming data encoded parameters corresponding to a first set of parametrized layers and a second set of parameterized layers.

11. The hybrid quantum-classical computing method of claim 1, wherein the reservoir circuit layer includes reservoir units corresponding to a set of quantum gates, wherein parameters of the quantum gates are independent of measurement feedback, input data, or reservoir state.

12. The hybrid quantum-classical computing method of claim 1, wherein the generation of the reservoir state is based on a plurality of activation functions, which introduce non-linearities into the operations performed by the quantum circuit, and a leak rate parameter.

13. The hybrid quantum-classical computing method of claim 1, wherein the updated measurement vector further comprises single-qubit expectation values and multi-qubit correlators, wherein both the single-qubit expectation values and the multi-qubit correlators are defined on a measurement graph.

14. The hybrid quantum-classical computing method of claim 1, wherein the method utilizes properties of a highly dimensional Hilbert space as a reservoir for encoding chaotic dynamics into the quantum circuit.

15. The hybrid quantum-classical computing method of claim 1, wherein prior measurements corresponding to the measurement feedback are derived from the quantum circuit parameterized by a preceding iteration of the computing method, wherein the prior measurements parameterize feedback layers.

16. The hybrid quantum-classical computing method of claim 1, wherein each of the transformation matrices is a fixed transformation matrix associated with a reservoir state, a measured state, and an input state.

17. The hybrid quantum-classical computing method of claim 1, wherein the time dependent input data comprises multicomponent time series data vectors.

18. The hybrid quantum-classical computing method of claim 1, further comprising using a classical co-processor to receive classical output from the quantum circuit and apply post-processing to produce refined data, and repeating operations that produce classical output to gather statistics for post-processing refinement.

19. The hybrid quantum-classical computing method of claim 1, further comprising the steps of repeating quantum circuit operations with each repetition compiled differently to enable post-processing suppression techniques and augmenting a quantum output with a classical co-processor for system enhancement based on accumulated statistics.

20. A quantum computing system comprising:
a data input and transformation module configured to receive time-dependent input data of a dynamical system and transform a first element of the input data into a set of transformed data, wherein the first element corresponds to an initial time;
a quantum data encoding module configured to encode the transformed data into a quantum circuit by performing a first set of quantum operations, wherein the quantum circuit comprises multiple layers, including data encoding layers, feedback layers, and a reservoir circuit layer;
a quantum measurement model configured to generate a previous measurement vector;
a quantum feedback module configured to integrate a measurement feedback from the previous measurement vector into the quantum circuit by executing a second set of quantum operations;
a random transformation module configured to output a quantum state configuration that is measured by the quantum measurement module to generate an updated measurement vector; and
a reservoir state creation module configured to produce a reservoir state from the updated measurement vector, a previous reservoir state, and the input data, wherein the system utilizes fixed transformation matrices which remain invariant across training and prediction phases of the system's operation.
